(19) United States
(12) Patent Application Publication
(10) Pub. No.: US 2025/0353116 A1
(43) Pub. Date: Nov. 20, 2025

(54) LASER SCORING SYSTEM BASED ON LIGHT QUANTITY FEEDBACK

(71) Applicant: K2 LASER SYSTEM INC., Anyang-si (KR)

(72) Inventors: MYOUNG SOO KIM, Anyang-si (KR); Yeoungcheol KIM, Anyang-si (KR); Ko Dong PARK, Anyang-si (KR); Yo Han Cho, Anyang-si (KR); Jae Hyok KIM, Anyang-si (KR); Jooho JUNG, Anyang-si (KR)

(21) Appl. No.: 19/054,874

(22) Filed: Feb. 16, 2025

(30) Foreign Application Priority Data
May 17, 2024 (KR) 10-2024-0064378
Jun. 20, 2024 (KR) 10-2024-0080358

(51) Int. Cl. B23K 26/359; B23K 26/03

(52) U.S. Cl. CPC B23K 26/359; B23K 26/03

(57) ABSTRACT

The present disclosure provides a laser scoring system based on light quantity feedback that uses an optical coherence tomography (OCT) sensor and a residual width measurement sensor to perform laser scoring, thereby reducing the cost of quality management for scored workpieces, quantifying the processing status and quality, and improving monitoring accuracy, and the laser scoring system based on light quantity feedback according to the present disclosure may comprise a laser source configured to irradiate a laser beam onto a workpiece to form a scoring groove, a sensor configured to sense and provide a depth of the scoring groove and a residual thickness of the workpiece, and a controller configured to control the output of the laser source based on the depth of the scoring groove and the residual thickness acquired from the sensor.

### CROSS-REFERENCE TO RELATED APPLICATION(S)

This application claims priority to Korean Patent Application Nos. 10-2024-0064378, filed on May 17, 2024, and 10-2024-0080358, filed on Jun. 20, 2024, in the Korean Intellectual Property Office, the disclosures of which are incorporated by reference herein in their entireties.

### TECHNICAL FIELD

The present disclosure relates to a laser scoring system based on light quantity feedback.

### DISCUSSION OF RELATED ART

An airbag for a vehicle is a device that inflates instantly toward passengers in the event of a vehicle collision to protect them from impact and is installed inside the steering wheel on the driver's side or on the dashboard in front of the front passenger seat, for example, the inside of the crash pad.

The airbag installed in the front passenger seat is usually called a passenger-side airbag (PAB), and a typical PAB module consists of an inflator that generates gas when a vehicle collision occurs, an airbag cushion that inflates by the gas supplied from the inflator, an airbag housing that is installed under the crash pad core installed in the front passenger seat and stores the airbag cushion, and a door-integrated chute that is connected between the crash pad core and the airbag housing.

The door-integrated chute is formed as a chute integrally formed on the bottom surface of the airbag door, and a hook is used for the airbag door to be combined with the crash pad core. Further, a skin foam composed of a skin layer and a foam layer formed by foam molding on the inner surface of the skin layer is attached to the outer surface of the airbag door and the crash pad core. The combination of the airbag door, crash pad core, and skin foam constitutes a crash pad as an interior material of an automobile installed in the front part of the front of the driver's seat and the front passenger seat.

Meanwhile, when a certain level of impact is applied to the vehicle, the crash pad must be torn to ensure smooth deployment of the airbag. To this end, some areas of the crash pad corresponding to the airbag door are perforated in a dotted line shape. The process of forming a weak point of the airbag door by perforation is called the scoring process.

In other words, scoring means making a groove that does not completely penetrate the workpiece or performing micro-processing that is invisible to the naked eye. Therefore, the scoring process can be applied not only to the crash pad described herein, but also to various industrial fields by leaving a very thin thickness unprocessed, thereby enhancing the inherent performance and marketability of the product.

In the past, this scoring process was performed using a knife, so it was difficult to maintain a constant processing depth, and there was also a problem that the quality control cost increased because the residual (unprocessed thickness) could not be determined numerically.

The information disclosed in the background of the present disclosure is only for improving understanding of the background of the present disclosure and therefore may include information that does not constitute prior art.

### SUMMARY

The present disclosure is to provide a laser scoring system based on light quantity feedback that uses an optical coherence tomography (OCT) sensor and a residual width measurement sensor to perform laser scoring, thereby reducing the cost of quality management for scored workpieces, quantifying the processing status and quality, and improving monitoring accuracy.

The laser scoring system based on light quantity feedback according to the present disclosure may comprise a laser source configured to irradiate a laser beam onto a workpiece to form a scoring groove, a sensor configured to sense and provide a depth of the scoring groove and a residual thickness of the workpiece, and a controller configured to control the output of the laser source based on the depth of the scoring groove and the residual thickness acquired from the sensor.

In one and more embodiment, the laser scoring system based on light quantity feedback may further comprise a beam splitter provided between the workpiece and the laser source, and the sensor may comprise an optical coherence tomography (OCT) sensor to provide light to the workpiece by the beam splitter to sense the depth of the scoring groove.

In one and more embodiment, the sensor may comprise a residual width measurement sensor positioned on a rear surface of the workpiece, opposite a front surface where the laser beam is incident, to sense the residual thickness of the workpiece.

In one and more embodiment, the laser scoring system based on light quantity feedback may further comprise an integrating sphere installed between the workpiece and the residual width measurement sensor.

In one and more embodiment, the integrating sphere may comprise a spherical reflector positioned at the rear of the workpiece and having an entrance through which a portion of the laser beam passing through the workpiece is incident, a shield installed on the inside of the reflector to prevent the laser beam from being directly incident on the residual width measurement sensor, and a cooling plate installed on the outside of the reflector to cool the reflector. and the residual width measurement sensor may be coupled to one side of the reflector.

In one and more embodiment, the laser scoring system based on light quantity feedback may further comprise a beam splitter provided between the workpiece and the laser source, and the sensor may include a monitoring sensor that provides light to the workpiece through the beam splitter while sensing the output value of the laser beam.

In one and more embodiment, the laser scoring system based on light quantity feedback may further comprise a neutral density (ND) filter disposed between the beam splitter and the monitoring sensor to pass only the wavelength of the laser beam and a diverting lens adjusting the size of the laser beam.

In one and more embodiment, the sensor may comprise a nozzle sensor mounted on a nozzle unit of a laser processing head and sensing an angle of the laser processing head and a distance from the workpiece.

The present disclosure provides a laser scoring system based on light quantity feedback that uses an optical coherence tomography (OCT) sensor and a residual width measurement sensor to perform laser scoring, thereby reducing the cost of quality management for scored workpieces, quantifying the processing status and quality, and improving monitoring accuracy.

### BRIEF DESCRIPTION OF THE DRAWINGS

A more complete appreciation of the present disclosure and many of the attendant aspects thereof will be readily obtained as the same becomes better understood by reference to the following detailed description when considered in connection with the accompanying drawings, wherein:

FIGS. 1, 2A, and 2B are views illustrating a laser scoring system based on light quantity feedback according to the present disclosure;

FIG. 3 is a view for explaining the configuration or operation of an OCT sensor in a laser scoring system based on light quantity feedback according to the present disclosure;

FIGS. 4A, 4B, 4C, and 4D are views for explaining the configuration or operation of a residual width measurement sensor in a laser scoring system based on light quantity feedback according to the present disclosure;

FIGS. 5A and 5B are views for explaining the configuration or operation of a monitoring sensor in a laser scoring system based on light quantity feedback according to the present disclosure;

FIG. 6 is a view for explaining the configuration or operation of a nozzle sensor in a laser scoring system based on light quantity feedback according to the present disclosure; and

FIGS. 7A, 7B, and 7C are views for explaining the configuration or operation of an integrating sphere in a laser scoring system based on light quantity feedback according to the present disclosure.

### DETAILED DESCRIPTION OF EXEMPLARY EMBODIMENTS

Hereinafter, preferred embodiments according to the present disclosure are described in detail with reference to the accompanying drawings.

The present disclosure is provided to more completely explain the present disclosure to those skilled in the art, and the following examples may be modified into various other forms, and the scope of the present disclosure is not limited to the following examples. Rather, these examples make the disclosure more complete and is provided in order to completely convey the spirit of the present disclosure to those skilled in the art.

Further, in the following drawings, the thickness and size of each layer are exaggerated for convenience and clarity of description, and the same symbols in the drawings refer to the same elements. As used herein, the term “and/or” includes any one and all combinations of one or more of the listed items. Further, as used herein, the term “connected” refers not only to the case where member A and member B are directly connected, but also to the case where member C is interposed between member A and member B to indirectly connect member A and member B.

The terms used herein are used to describe specific embodiments and are not intended to limit the invention. As used herein, the singular forms include the plural forms unless the context clearly indicates otherwise. Additionally, as used herein, the terms “comprise, include,” and/or “comprising, including”
specify the presence of stated shapes, numbers, steps, operations, members, elements and/or groups thereof but is not intended to exclude the presence or addition of one or more other shapes, numbers, operations, members, elements and/or groups thereof.

As used herein, the terms “first,” “second,” etc. are used to describe various members, parts, regions, layers and/or portions, but it is obvious that these members, parts, regions, layers and/or parts should not be limited by these terms. These terms are used only to distinguish one member, component, region, layer or portion from another member, component, region, layer or portion. Accordingly, a first member, component, region, layer or portion described below may refer to a second member, component, region, layer or portion without departing from the teachings of the present disclosure.

Space-related terms such as “beneath,” “below,” “lower,” “above,” and “upper” may be used to facilitate understanding of one element or feature and another element or feature shown in the drawings. These space-related terms are for easy understanding of the present disclosure according to various process states or usage states of the present disclosure, and are not intended to limit the present disclosure. For example, if an element or feature in a drawing is inverted, an element or feature described as “beneath” or “below” becomes “above” or “upper.” Therefore, “below” is a concept encompassing “above” or “below.”

Further, the controller and/or other related devices or components according to the present disclosure may be implemented using any suitable hardware, firmware (e.g., application-specific integrated circuits), software, or a suitable combination of software, firmware and hardware. For example, various components of a controller and/or other related devices or components according to the present disclosure may be formed on one integrated circuit chip, or on separate integrated circuit chips. Further, the various components of the controller may be implemented on a flexible printed circuit film and can be formed on a tape carrier package, a printed circuit board, or the same substrate as the controller. Further, the various components of the controller may be processes or threads running on one or more processors in one or more computing devices, which may execute computer program instructions and interact with other components to perform various functions mentioned below. Further, the computer program instructions are stored in a memory that can be executed on the computing device using a standard memory device, such as a random access memory, for example. Further, the computer program instructions may be stored on other non-transitory computer readable media, such as a CD-ROM, a flash drive, etc. Further, those skilled in the art should recognize that the functions of various computing devices may be combined with each other, integrated into a single computing device, or the functions of a particular computing device may be distributed to one or more other computing devices without departing from the scope of the present disclosure.

For example, a controller according to the present disclosure may be operated in a typical commercial computer comprising a central processing unit, a mass storage device such as a hard disk or a solid-state disk, a volatile memory device, an input device such as a keyboard or mouse, and an output device such as a monitor or printer.

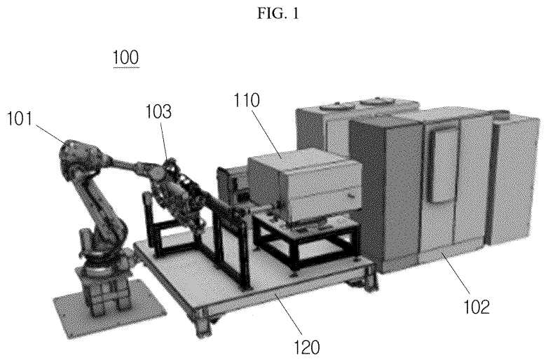

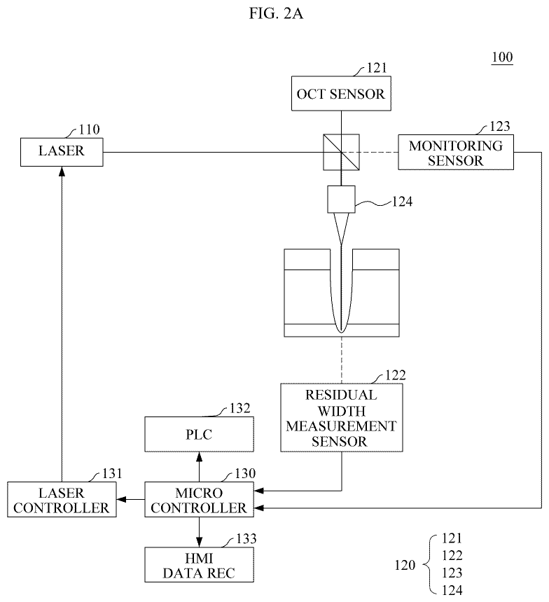

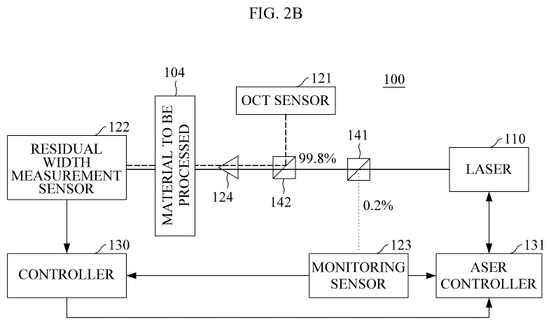

FIGS. 1 to 2B are views illustrating a laser scoring system based on light quantity feedback 100 according to the present disclosure.

As shown in FIG. 1, a laser scoring system 100 according to the present disclosure may include a laser source 110, a sensor 120, and a controller 130.

The laser source 110 may output a single laser beam. The laser source 110 may include a solid, gas, or liquid laser source 110. For example, solid laser sources 110 may generate laser using a solid material. Representative solid lasers may include Nd:YAG lasers, fiber lasers, etc. Solid lasers may have high output and excellent beam quality, and be suitable for processing metals. The gas laser sources 110 may generate lasers using gas. Representative gas lasers may include CO2 lasers, helium-neon lasers, etc. Further, gas lasers may have high output and low price, and be suitable for processing non-metals.

In the present disclosure, the laser source 110 may include a high-output CO2 laser source 110. The CO2 laser source 110 may have a laser wavelength with stable output and quality, can process multilayer materials smoothly and quickly, and, depending on the polymer classification of the plastic, the absorption rate of polyimide is excellent in the wavelength range of about 10.6 μm rather than about 1 μm.

The sensor 120 may include an OCT sensor 121 and a residual width measurement sensor 122 and may further include at least one of a monitoring sensor 123 and a nozzle sensor 124. The specific configuration and operation of this sensor 120 is described again below.

The controller 130 (or referred to as a control feedback system) may precisely control laser output, etc. by receiving feedback signals from the sensor 120 under monitoring through the real-time sensor 120 and may further include a laser controller 131.

In addition, the present disclosure may further include auxiliary components. In one or more embodiment, the present disclosure may include a laser transport unit 101, such as a 3D robot manipulator, which is synchronized with a laser optical system to enable fast and precise position control of the laser. In one or more embodiment, the present disclosure may further include a utility 102 such as dust collection and cooling systems for maintaining consistent lot-by-lot processing and optimized working environment by completely removing residues and suppressing dust. In the drawing, not shown reference number 103 is a positioning jig that fixes a workpiece 104 to a predetermined position so that scoring is formed.

As shown in FIG. 2A and FIG. 2B, the laser scoring system 100 according to the present disclosure may include the laser source 110, the sensor 120, and the controller 130. In one or more embodiments, the present disclosure may further include a first beam splitter 141 and a second beam splitter 142. In addition, the sensor 120 in the present disclosure may include the OCT sensor 121, the residual width measurement sensor 122, the monitoring sensor 123, and the nozzle sensor 124. As described above, the present disclosure may include a (micro) controller 130 and a laser controller 131. In one or more embodiments, the controller 130 may further be connected to a programmable logic controller (PLC) 132 for programming or modification and a human-machine interface (HMI) 133 for control or monitoring by a user.

As described above, the laser source 110 may be configured to irradiate a laser beam onto a workpiece 104 to form a scoring groove 105. In addition, as described above, the sensor 120 may sense the depth of the scoring groove 105 and the residual thickness of the workpiece 104 and provide feedback to the controller 130. Further, the controller 130 may control the output of the laser source 110 based on the depth and residual thickness of the scoring groove 105 received as feedback from the sensor 120. In one or more embodiments, the controller 130 may transmit a control signal to the laser controller 131, and the laser controller 131 may control the laser source 110 based on signals from the monitoring sensor 123 and the controller 130.

In one or more embodiments, the first beam splitter 141 may be provided between the workpiece 104 and the laser source 110, and a monitoring sensor 123 may receive a portion (e.g., approximately 0.2%) of the laser beam from the first beam splitter 141, sense the output value of the laser beam, and provide it to the controller 130 and/or the laser controller 131. In one or more embodiments, the monitoring sensor 123 may include or be referred to as a reference sensor. In one or more embodiments, the laser scoring system 100 according to the present disclosure may further include a neutral density (ND) filter that passes only the wavelength of the laser beam and a diverting lens 1231 for adjusting the size of the laser beam, which is disposed between the first beam splitter 141 and the monitoring sensor 123.

In one or more embodiments, the second beam splitter 142 may be provided between the workpiece 104 and the laser source 110, and the OCT sensor 121 may provide light to the workpiece 104 through the second beam splitter 142 to sense the depth of the scoring groove 105 and provide it to the controller 130 and/or the laser controller 131.

In one or more embodiments, the residual width measurement sensor 122 is positioned on the rear surface of the workpiece 104 opposite the front surface where the laser beam is incident to sense the residual thickness of the workpiece 104 and provide the same to the controller 130 and/or the laser controller 131. In one or more embodiments, the residual width measurement sensor 122 may include or be referred to as a residual width measurement sensor.

In one or more embodiments, the nozzle sensor 124 may be mounted on a nozzle of the laser processing head to sense the angle of the laser processing head and the distance to the workpiece 104 and provide these to the controller 130 or the laser controller 131.

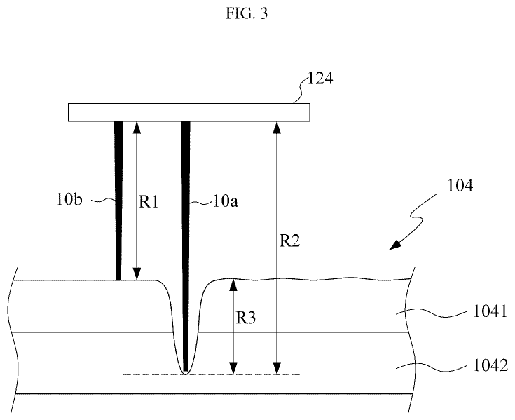

FIG. 3 is a view for explaining the configuration or operation of the OCT sensor 121 in a laser scoring system 100 based on light quantity feedback according to the present disclosure.

As illustrated in FIG. 3, the OCT sensor 121 may capture the surface of the workpiece 104 during, before, or after laser processing using an optical coherence tomography (OCT) method. It can be generally implemented using a Michelson interferometer or a Mach-Zehnder interferometer. Light generated from a single light source with continuous wavelengths may be split into two directions through a second beam splitter, and each light may be expressed as an inspection light transmitted to the workpiece 104 and a reference beam transmitted to a reference stage. The inspection light may be reflected by the workpiece 104 and enter the optical system. The reference light may travel the same distance as the optical path of the inspection light and may be then synthesized with the inspection light. The interference light generated by the synthesis is analyzed by a spectrometer to analyze the optical path difference between the inspection light and the reference light, thereby monitoring the change in distance between the surface of the workpiece 104 and the laser source. It is difficult to measure the thickness of the workpiece 104 through which the laser beam is not transmitted by the residual width measurement sensor 122. The OCT sensor 121 measures the distance between the reference surface and the bottom of the scoring groove 105 to calculate the depth of the scoring groove from the difference.

Specifically, as illustrated in FIG. 3, a beam penetrating into a groove formed by a laser beam may be defined as a first measuring beam 10a, a beam preceding the first measuring beam and reaching the surface of the workpiece 104 may be defined as a second measuring beam 10b, and since the distance by the first measuring beam is R2 and the distance by the second measuring beam is R1, the distance difference between R2 and R1 becomes the penetration depth of the laser beam. In one or more embodiments, the workpiece 104 may include a first layer 1041 of the workpiece, such as an injection molded foam, forming the interior of the pad, through which the processing laser beam completely penetrates, and a second layer 1042 of the workpiece, such as a plastic, forming the exterior of the pad, through which the processing laser beam partially processes.

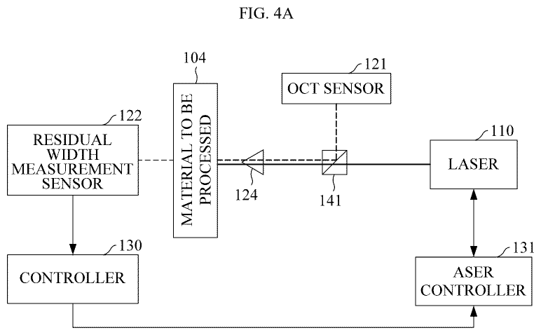

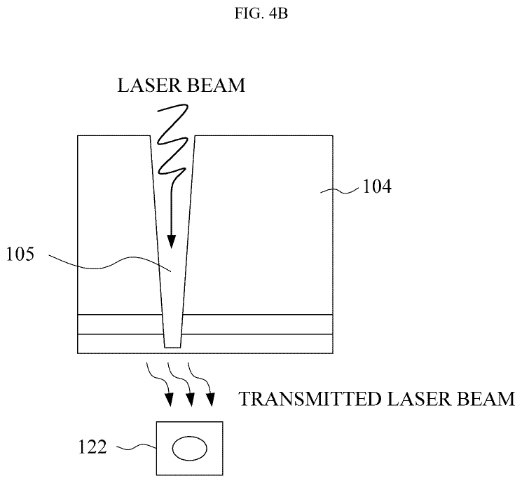

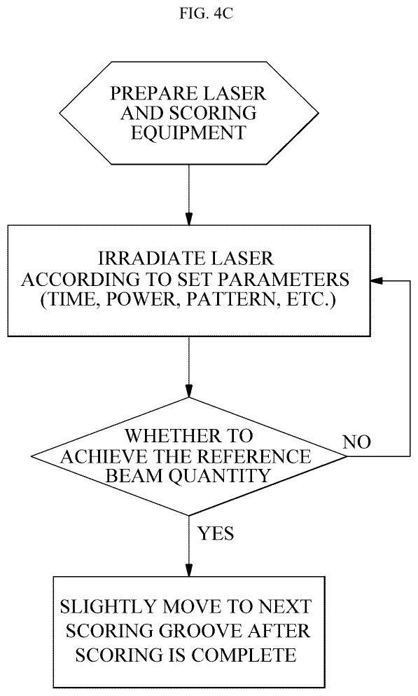

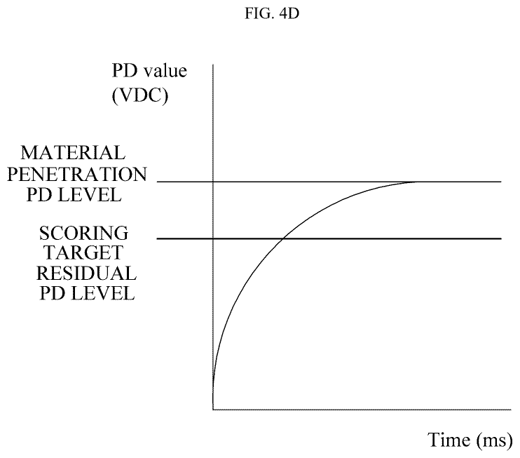

FIGS. 4A to 4D are views for explaining the configuration or operation of a residual width measurement sensor in a laser scoring system based on light quantity feedback 100 according to the present disclosure.

As shown in FIGS. 4A and 4B, the residual width measurement sensor 122 may be a photo diode positioned in the direction of the workpiece 104 being processed by the laser. Even if the workpiece 104 may be not completely penetrated, the residual width of the material of the workpiece 104 may be measured based on the transmitted light quantity data. To increase the measurement accuracy for light radiating in irregular directions, an integrating sphere 1221 may be additionally positioned in front of the residual width measurement sensor 122. The residual width measurement sensor 122 capable of measuring a CO₂ laser having a wavelength of approximately 10.6 μm may be positioned opposite the laser entry direction with the workpiece 104 in between. In one or more embodiments, the sensitivity of the residual width measurement sensor 122 may be adjusted so that the residual thickness of the workpiece 104 is between about 0.15 mm and about 0.17 mm.

As shown in FIG. 4C, whether or not the laser beam is continuously emitted may be determined depending on the light level of the laser beam that has passed through the scoring groove 105 of the workpiece 104. In one or more embodiments, after preparing the laser scoring system 100 according to the present disclosure, the laser oscillation (time, power, pattern, etc.) may be started according to the set parameter values to perform the scoring process, and when they reach the preset standard transmitted light quantity or beam quantity, the processing of the scoring groove 105 may be completed, and it can move slightly to the next scoring groove 105.

As shown in FIG. 4D, the memory of the controller 130 stores a preset scoring target residual PD level (i.e., transmitted light quantity or transmitted beam quantity) over time and a penetration PD level of the workpiece 104, and when it reaches the scoring target residual PD level during the formation of the scoring groove 105, the controller 130 controls the laser head to move for processing of the next scoring groove 105.

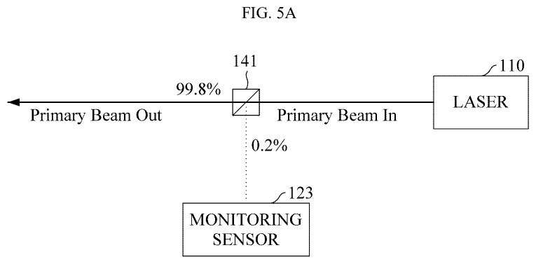

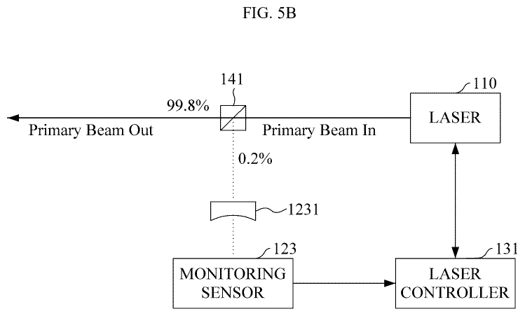

FIGS. 5A and 5B are views for explaining the configuration or operation of the monitoring sensor 123 in a laser scoring system based on light quantity feedback 100 according to the present disclosure.

As shown in FIG. 5A and FIG. 5B, the monitoring sensor 123 according to the present disclosure may sense the output of a laser beam branched through the first beam splitter (e.g., a wedge prism) and provide it to the laser controller 131. In one or more embodiments, the first beam splitter may reflect a portion of the primary laser beam emitted from the laser source 110 at an angle of about 2° to about 45° so that it is incident on the monitoring sensor 123. In one or more embodiments, the first beam splitter may reflect about 0.0001% to about 0.2% of the total output of the primary beam to the monitoring sensor 123 and transmit the remaining about 99.8% to about 99.9999% of the energy (primary beam out). This reflection-to-transmittance ratio may be set to suit the environment or purpose. In one or more embodiments, the monitoring sensor 123 may be further equipped with the neutral density ND filter that allows only the CO2 laser wavelength to pass through and the diverging lens 1231 for beam size adjustment. The laser controller 131 may calibrate the output of the laser according to the data measured by the monitoring sensor 123.

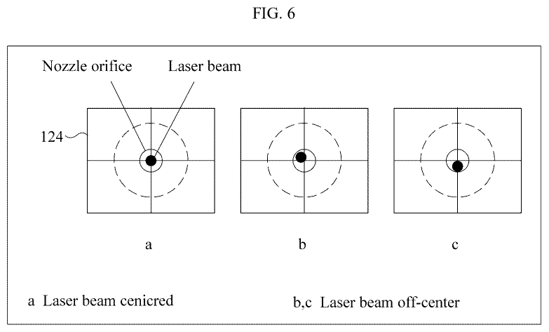

FIG. 6 is a view for explaining the configuration or operation of the nozzle sensor 124 in a laser scoring system 100 based on light quantity feedback according to the present disclosure.

As illustrated in FIG. 6, the nozzle sensor 124 according to the present disclosure may be a sensor mounted on the nozzle of a laser processing head and may measure the distance between the head and the processing surface. This nozzle sensor 124 may collect electrical signals through a ceramic ring inserted into the processing head and may measure the position of the laser head, the angle of the laser head, and the distance to the workpiece 104 by the collected signals, and provide them to the controller 130 and/or the laser controller 131. Then, the controller 130 and/or the laser controller 131 may calibrate the spot beam to come out from the exact center of the nozzle based on this. In FIG. 6, (a) illustrates the laser beam being positioned at the center of the nozzle orifice, and (b) and (c) illustrate the laser beam being positioned off at the center of the nozzle orifice.

Meanwhile, the system according to the present disclosure may include the residual width measurement sensor 122, for example, a photodiode or a photodetector, as described above, to measure laser energy transmitted through the workpiece 104. However, the energy measurement results of a photodetector are sensitive to the position and angle of the incident beam. This causes errors in the residual thickness, which leads to incorrect output control and calibration of the system. Therefore, to reduce sensing error, the laser scoring system 100 of the present disclosure may further include the integrating sphere 1221.

In one or more embodiments, the integrating sphere 1221 may captures light emitted from the light source, and laser light entering inside is reflected multiple times (Lambertian reflectance) by striking a reflective wall. This creates a uniform distribution of light.

That is, the laser scoring system 100 according to the present disclosure may include the integrating sphere 1221 to effectively measure the light quantity that penetrates and scatters through the remaining portion of the workpiece 104 that is not penetrated.

The integrating sphere 1221 may capture light emitted from a light source and enable uniform distribution of light through repeated Lambertian reflections inside. Lambertian reflection is a reflection in which the luminance of the surface is isotropic, meaning that the apparent brightness is the same regardless of the angle from which the observer views it.

The laser may emit light in a straight line, so that it may be measured even with a detector with a small opening 1222. However, the light measured by the laser scoring system 100 according to the present disclosure may pass through the workpiece 104 and be radiated, so that it is difficult to measure an accurate amount using a general photodetector.

Accordingly, the integrating sphere 1221 of the laser scoring system 100 according to the present disclosure may form a uniform energy distribution to increase measurement accuracy and also prevent the device from being damaged by a small light quantity but high density laser energy being directly transmitted to the sensor.

Here, Lambertian reflection means that on an ideal diffusely reflecting surface, the radiance is the same regardless of the angle from which the surface is viewed, so the light quantity measured is the same.

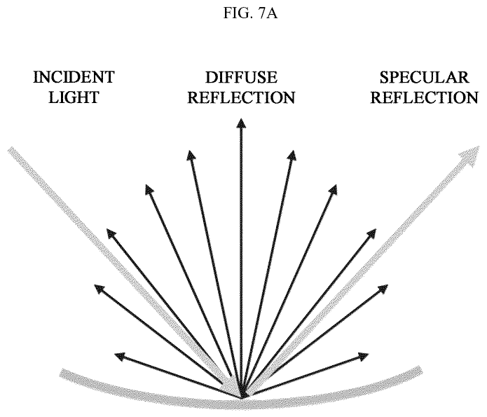

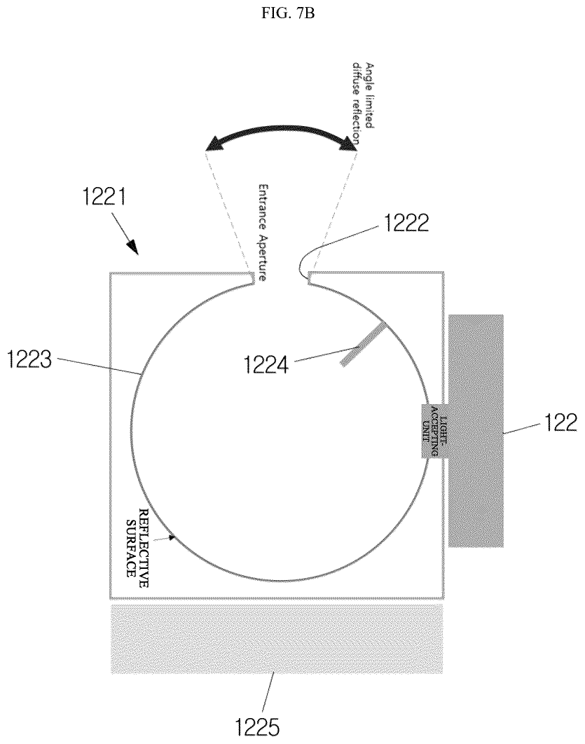

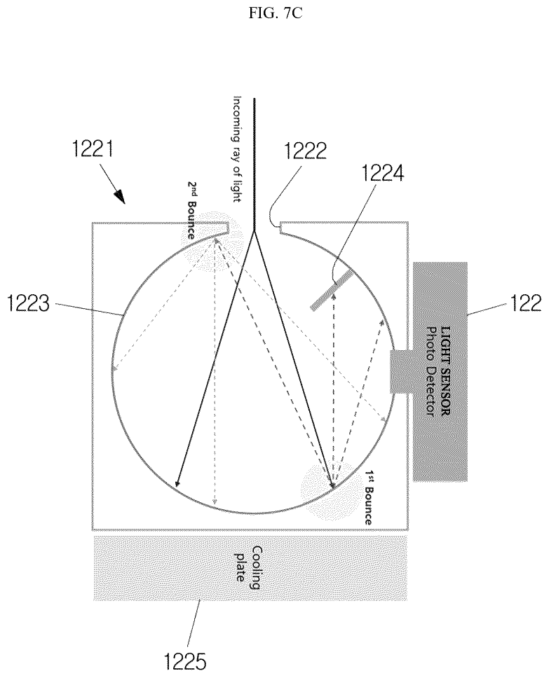

FIGS. 7A to 7C are views for explaining the configuration or operation of the integrating sphere 1221 in a laser scoring system based on light quantity feedback 100 according to the present disclosure.

Here, FIG. 7A is a view for explaining the Lambertian reflection law. On an ideal diffusely reflecting surface, the radiance is the same regardless of the angle from which the surface is viewed, so the light quantity measured is the same. More specifically, the Lambertian's law of reflection states that light incident on a surface is scattered equally in all directions within a solid angle of 2π steradians of the surface. Additionally, Lambertian emission implies that the light quantity observed, or the intensity of light emitted, from an ideally light-diffusing or reflecting surface is directly proportional to the cosine of the angle between the surface and the observer. When an outgoing ray of light hits the walls of the integrating sphere 1221, the light is reflected and scattered many times until the light hitting any of the walls of the sphere has the same intensity.

As shown in FIG. 7B, the integrating sphere according to the present disclosure may comprise a spherical reflector 1223 positioned at the rear of the workpiece 104 and having an entrance 1222 through which a portion of the laser beam passing through the workpiece 104 is incident, a shield 1224 installed on the inside of the reflector 1223 to prevent the laser beam from being directly incident on the residual width measurement sensor 122, and a cooling plate 1225 installed on the outside of the reflector 1223 to cool the reflector 1223. In one or more embodiments, the residual width measurement sensor 122, i.e., a photodetector, may be coupled to one side of the reflector 1223.

In one or more embodiments, the reflector 1223 may be made of copper (Cu) for reflection of the CO₂ laser wavelength (10.6 μm) and may be internally coated with a special material. Ideally, the interior of the integrating sphere 1221 should be a perfect reflector, with the reflectivity of the material being constant regardless of the wavelength range. Traditionally, barium sulfate (BaSO₄) is used, but it ages quickly when exposed to ultraviolet rays or moisture. Since the decomposition of the coating material may also affect the refraction of the incident light, various materials other than barium sulfate may be used to replace it. Further, in one or more embodiments, the total area of all components including the photodetector may not exceed approximately 5% of the area of the sphere.

In one or more embodiments, the integrating sphere 1221 may have the entrance 1222) having an acceptance angle, and the acceptance angle increases as the size of the integrating sphere 1221 increases. To improve measurement accuracy, the entrance 1222 may have a knife edge design. Further, the reflective surface of the reflector 1223 may reduce the spatial and directional sensitivity of the photodetector and promote the expansion and diffusion of the laser energy propagated along the travel path. In addition, the shield, also referred to as a baffle, may be installed so that the incident laser beam does not directly hit the photodetector. Further, the photodetector may be installed on the reflector 1223 so that only scattered light can be seen and the incident light cannot be seen. The photodetector, i.e., the residual width measurement sensor 122, may convert the detected value into an electrical signal and then transmit it to the controller 130.

As illustrated in FIG. 7C, the integrating sphere 1221 according to the present disclosure may generally operate as follows.

First, some of the laser light projected onto the rear surface of the workpiece 104 may enter the interior of the hollow spherical reflector 1223 through the small entrance 1222. Then, the light may be multi-reflected on the inner coating surface of the reflector 1223 and diffused into the sphere according to the Lambertian reflection law. Finally, the light may be diffused to the residual width measurement sensor 122, which is located perpendicular to the direction from which the beam is incident and be sampled.

Although the present disclosure has been described with an example of forming a scoring groove in an airbag crash pad of an automobile, the present disclosure can also be applied to the following fields.

Packaging material cutting line: For non-laminated foils such as polyethylene terephthalate (PET), amorphous polyethylene terephthalate (APET), polyethylene (PE), polylactic acid (PLA), oriented polypropylene (OPP), polyamide (PA), and composite foils such as PET/PE (two-layer packaging material composed of PPET film and PE film), PET/Alu/PE (three-layer packaging material composed of PET film, aluminum film, and PE film), PET/Paper/Paper (three-layer packaging material composed of PET film and two layers of paper), an easy cut line can be created to help the user open the package.

Bending line: When the material needs to be folded and formed, pre-creases can be processed to facilitate folding.

Decoration: Multilayer materials can be processed at different depths to expose multiple layers and colors.

Breaking line: In the case of semiconductors, wafers, solar modules, glass, ceramics, etc. that are easily broken during complete separation, the cutting line can be processed to prevent cracking of the material due to the separation operation.

The above description is only one example for implementing a laser scoring system based on light quantity feedback according to the present disclosure, and the present disclosure is not limited to the above embodiment, and as claimed in the following claims, it will be understood that the technical spirit of the present disclosure encompasses a range in which various modifications can be implemented without departing from the gist of the present disclosure.

What is claimed is:

1. A laser scoring system based on light quantity feedback, comprising:
a laser source configured to irradiate a laser beam onto a workpiece to form a scoring groove;
a sensor configured to sense and provide a depth of the scoring groove and a residual thickness of the workpiece; and
a controller configured to control the output of the laser source based on the depth of the scoring groove and the residual thickness acquired from the sensor,
wherein the sensor comprises a residual width measurement sensor positioned on a rear surface of the workpiece, opposite a front surface where the laser beam is incident, to sense the residual thickness of the workpiece,
wherein the laser scoring system further comprising an integrating sphere installed between the workpiece and the residual width measurement sensor, and
wherein the integrating sphere comprises a spherical reflector positioned at the rear of the workpiece and having an entrance through which a portion of the laser beam passing through the workpiece is incident;
a shield installed on the inside of the reflector to prevent the laser beam from being directly incident on the residual width measurement sensor; and
a cooling plate installed on the outside of the reflector to cool the reflector,
wherein the residual width measurement sensor is coupled to one side of the reflector.

2. The laser scoring system based on light quantity feedback of claim 1, further comprising: a beam splitter provided between the workpiece and the laser source,
wherein the sensor comprises an optical coherence tomography (OCT) sensor to provide light to the workpiece by the beam splitter to sense the depth of the scoring groove.

3. The laser scoring system based on light quantity feedback of claim 1, further comprising: a beam splitter provided between the workpiece and the laser source,
wherein the sensor includes a monitoring sensor that provides light to the workpiece through the beam splitter while sensing the output value of the laser beam.

4. The laser scoring system based on light quantity feedback of claim 3, further comprising a neutral density (ND) filter disposed between the beam splitter and the monitoring sensor to pass only the wavelength of the laser beam, and a diverting lens adjusting the size of the laser beam.

5. The laser scoring system based on light quantity feedback of claim 1, wherein the sensor comprises a nozzle sensor mounted on a nozzle unit of a laser processing head and sensing an angle of the laser processing head and a distance from the workpiece.
